(19) United States
(12) Patent Application Publication
(10) Pub. No.: US 2026/0233314 A1
(43) Pub. Date: Aug. 13, 2026

(54) CUTTING INSERT AND CUTTING TOOL ON WHICH SAME IS MOUNTED

(71) Applicant: KORLOY INC., Seoul (KR)

(72) Inventors: Nam Seon LEE, Cheongju-si, Chungcheongbuk-do (KR); Sang Yong LEE, Cheongju-si, Chungcheongbuk-do (KR); Min Seok OH, Cheongju-si, Chungcheongbuk-do (KR); Young Heum KIM, Cheongju-si, Chungcheongbuk-do (KR)

(73) Assignee: KORLOY INC., Seoul (KR)

(21) Appl. No.: 19/470,738

(22) PCT Filed: Mar. 7, 2024
(86) PCT No.: PCT/KR2024/002943

§ 371 Date: Sep. 29, 2025

(30) Foreign Application Priority Data
Apr. 10, 2023 (KR) 10-2023-0046630

(51) Int. Cl. B23C 5/20; B23C 5/06

(52) U.S. Cl. CPC B23C 5/202; B23C 5/06; B23C 2200/203

(57) ABSTRACT

A cutting insert according to an embodiment of the present invention comprises a top surface, a bottom surface, a side surface, a fastening hole penetrating the top surface and the bottom surface, and a cutting edge at which the top surface and the side surface are connected to each other. The cutting edge includes a main cutting edge, a first corner cutting edge extending from one side of the main cutting edge, and a second corner cutting edge extending from the other side of the main cutting edge. When viewed from the side surface, the main cutting edge has an asymmetrical upwardly convex shape with respect to an imaginary center line passing through the fastening hole, and when viewed from the top surface, the main cutting edge has a straight shape. A first contact point where the main cutting edge and the first corner cutting edge meet is positioned higher from the bottom surface than a second contact point where another main cutting edge adjacent to the main cutting edge and the first corner cutting edge meet.

### TECHNICAL FIELD

The present invention relates to a cutting insert and a cutting tool equipped with the same, and more specifically, to a cutting insert capable of increasing service life and a cutting tool equipped with the same.

### BACKGROUND ART

In general, a cutting insert is fastened to a cutting tool mounted on a machine tool and is used for cutting a workpiece, such as mechanical parts made of iron, nonferrous metals, or nonmetallic materials.

Such a cutting insert includes a top surface, a bottom surface facing in the opposite direction, a side surface connecting the top and bottom surfaces, and a cutting edge forming the boundary between the top surface and the side surface, the cutting edge substantially cutting the workpiece.

Meanwhile, in the case of a high-feed milling tool, it generally refers to a tool having a approach angle of less than 15°. Although a small approach angle results in a smaller cutting depth per pass, the chip thickness is thin, allowing it to be used for machining various shapes. In particular, it is often used for machining mold parts, and mold materials are, by nature, high in hardness and complex in shape. Therefore, it must be capable of various multipurpose machining (ramping, helical), and chip disposal performance in shape machining is extremely important.

However, in the case of a conventional quadrilateral cutting insert for high-feed machining, the clearance angle of the corner portion is made large to suit such shape machining. In this case, although various shape machining is possible, there has been a problem in that corner chipping of the cutting insert frequently occurs when machining mold materials of high hardness.

In addition, in a conventional quadrilateral cutting insert for high-feed machining, the helix direction of the cutting edge is set in the “+” direction. In this case, cutting performance is slightly improved, but the chips of high-hardness mold materials flow to the unused corner of the cutting insert, which can damage the unused corner.

[Prior Art Document] Korean Laid-Open Patent No. 10-2016-0019952 (Publication Date: Feb. 22, 2016)

### DETAILED DESCRIPTION OF INVENTION

### Technical Problem

The present invention has been made to solve the above-described problems, and an object of the present invention is to provide a cutting insert and a cutting tool equipped with the same, which can impart both sufficient clearance angle and rigidity to the cutting insert, and also increase service life by protecting the unused corner.

### Technical Solution

In order to achieve the above object, a cutting insert according to one embodiment of the present invention comprises: a top surface, a bottom surface, a side surface, a fastening hole penetrating the top surface and the bottom surface, and a cutting edge where the top surface and the side surface are connected to each other, wherein the cutting edge includes a main cutting edge, a first corner cutting edge extending from one side of the main cutting edge, and a second corner cutting edge extending from the other side of the main cutting edge, wherein, when viewed from the side surface, the main cutting edge has an asymmetrical upwardly convex shape with respect to an imaginary center line passing through the fastening hole, and, when viewed from the top surface, the main cutting edge has a straight shape, and a first contact point where the main cutting edge and the first corner cutting edge meet is positioned higher from the bottom surface than a second contact point where another main cutting edge adjacent to the main cutting edge and the first corner cutting edge meet.

In addition, when viewed from the top surface, the cutting insert is rotationally symmetrical at 90°×n (where n is a natural number) with respect to the imaginary center line, the first corner cutting edge is symmetrical with respect to an imaginary diagonal center line passing through the center of the fastening hole, and the second corner cutting edge is symmetrical with respect to another imaginary diagonal center line passing through the center of the fastening hole.

In addition, a first corner portion of the bottom surface corresponding to the first corner cutting edge is asymmetrical with respect to the imaginary diagonal center line, and a second corner portion of the bottom surface corresponding to the second corner cutting edge is asymmetrical with respect to the imaginary diagonal center line.

In addition, a corner clearance surface extending from the first corner cutting edge has a clearance angle that increases from the first contact point toward the second contact point.

In addition, the shortest distance between a third contact point, where the first corner portion is connected to an edge portion of the bottom surface, and the first contact point is shorter than the shortest distance between a fourth contact point, where the first corner portion is connected to another edge portion of the bottom surface adjacent to the edge portion, and the second contact point.

In addition, the top surface is provided with a plurality of concave dimples along the cutting edge, and the plurality of dimples gradually increase in length from the first contact point toward the second contact point.

### Effects of Invention

The cutting insert according to an embodiment of the present invention having the above-described configuration has the following effects.

In the cutting insert of the present invention, since the main cutting edge has an asymmetrical upwardly convex shape (when viewed from the side) and a substantially straight shape (when viewed from the top), chips separated from the workpiece during machining process do not flow from the first corner cutting edge toward the second corner cutting edge but curl in place, thereby allowing the opposite corner (the corner where the second corner cutting edge is located) to be protected.

In addition, when the cutting insert of the present invention is used for high-feed ramping, the clearance angle on the inner side (the side of the first corner cutting edge) of the cutting insert can be appropriately secured while reinforcing the rigidity of the main cutting edge.

Meanwhile, although not explicitly described, the present invention also includes other effects that can be expected from the above-described configuration.

### BRIEF DESCRIPTION OF THE DRAWINGS

FIG. 1 is a perspective view of a cutting insert according to an embodiment of the present invention.

FIG. 2 is a side view of the cutting insert of FIG. 1.

FIG. 3 is a plan view of the cutting insert of FIG. 1.

FIG. 4 is a bottom view of the cutting insert of FIG. 1.

FIG. 5 is a perspective view of the cutting insert of FIG. 1 as viewed toward the bottom surface.

FIG. 6 illustrates a cutting tool in which the cutting insert of FIG. 1 is mounted.

FIG. 7 is an exploded assembly view of the cutting insert of FIG. 1, a fastening bolt, and the cutting tool.

### BEST MODE FOR EMBODYING INVENTION

Hereinafter, embodiments of the present invention will be described in detail with reference to the accompanying drawings so that those having ordinary skill in the technical field to which the present invention belongs can carry them out. However, the present invention can be implemented in various different embodiments and is not limited to the embodiments described herein. For reference, in this specification, the terms “first,” “second,” and the like do not indicate order, but are terms used to distinguish components having the same name.

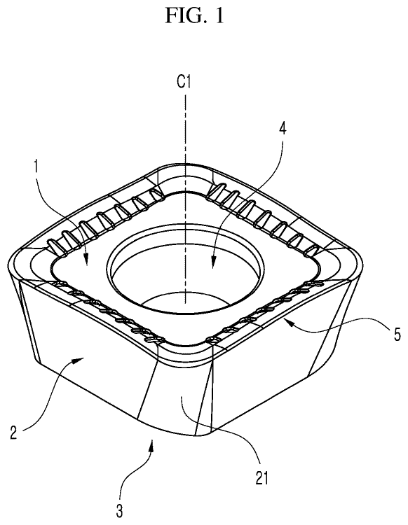

As shown in FIG. 1, a cutting insert according to an embodiment of the present invention includes a top surface (1), a bottom surface (3), a side surfaces? (2), a fastening hole (4) penetrating the top surface (1) and the bottom surface (3), and a cutting edge (5) located at a portion where the top surface (1) and the side surface (2) are connected to each other. The cutting insert of the present invention, when viewed from the top surface (1), has a substantially square shape, and the bottom surface (3) serves as a mounting surface, while the top surface (1) serves as a rake surface, thereby constituting a single-sided cutting insert.

The cutting edge (5) includes a main cutting edge (51), a first corner cutting edge (52) extending from one side of the main cutting edge (51), and a second corner cutting edge (53) extending from the other side of the main cutting edge (51).

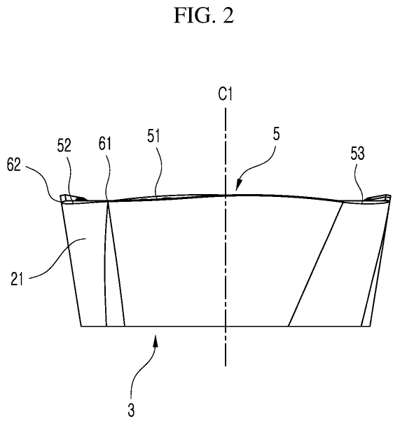

As shown in FIG. 2, when the cutting insert of the present invention is viewed from the side surface (2), the main cutting edge (51) has an asymmetrical upwardly convex shape with respect to an imaginary center line (C1) passing through the fastening hole (4).

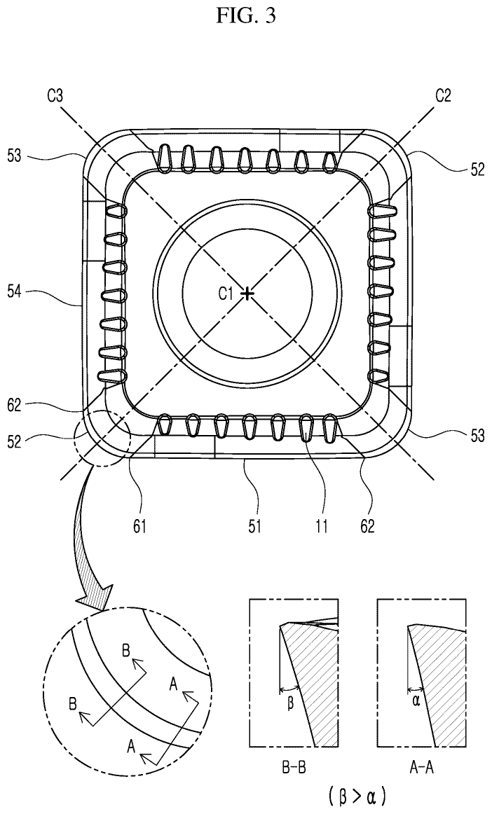

In addition, as shown in FIG. 3, when the cutting insert of the present invention is viewed from the top surface (1), the main cutting edge (51) has a substantially straight shape.

In this way, by having the main cutting edge (51) in an asymmetrical upwardly convex shape (when viewed from the side) and a substantially straight shape (when viewed from the top), chips separated from the workpiece during machining process do not flow from the first corner cutting edge (52) toward the second corner cutting edge (53) but curl in place, thereby allowing the opposite corner (the corner where the second corner cutting edge is located) to be protected.

Meanwhile, as shown in FIG. 2, a first contact point (61) where the main cutting edge (51) and the first corner cutting edge (52) meet is positioned higher from the bottom surface (3) than a second contact point (62) where another main cutting edge (54) adjacent to the main cutting edge (51) and the first corner cutting edge (52) meet.

As shown in FIG. 3, when the cutting insert of the present invention is viewed from the top surface (1), the cutting insert is rotationally symmetrical at 90°×n (where n is a natural number) with respect to the imaginary center line (C1). Therefore, when viewed from the top surface, the cutting insert of the present invention can have four identical main cutting edges and four identical corner cutting edges.

In addition, the first corner cutting edge (52) is symmetrical with respect to an imaginary diagonal center line (C2) passing through the center of the fastening hole (4), and the second corner cutting edge (53) is symmetrical with respect to another imaginary diagonal center line (C3) passing through the center of the fastening hole (4).

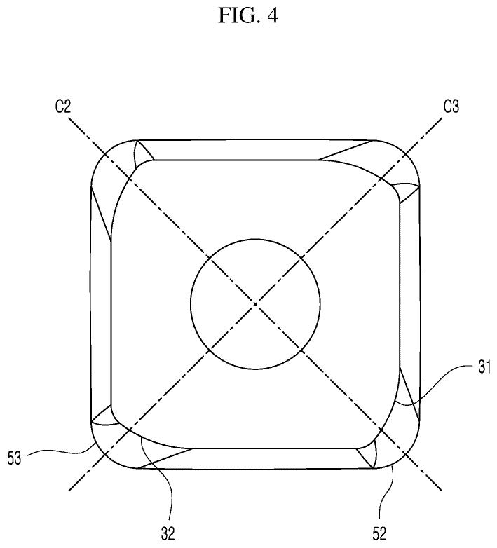

As shown in FIG. 4, a first corner portion (31) of the bottom surface corresponding to the first corner cutting edge (52) is asymmetrical with respect to the imaginary diagonal center line (C2). For reference, the term “corresponding” means, as can be seen from FIGS. 3 and 4, that when viewed in the direction from the top surface (1) toward the bottom surface (3) (or from the bottom surface toward the top surface) along a direction perpendicular to the surfaces, the portions overlap each other.

In addition, a second corner portion (32) of the bottom surface (3) corresponding to the second corner cutting edge (53) is asymmetrical with respect to the imaginary diagonal center line (C2).

As shown in FIG. 3, a corner clearance surface (21) extending from the first corner cutting edge (52) has a clearance angle that increases from the first contact point (61) toward the second contact point (62) (β>α).

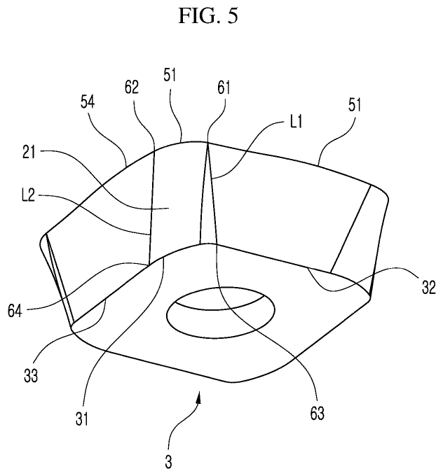

As shown in FIG. 5, the shortest distance (L1) between a third contact point (63), where the first corner portion (31) is connected to an edge portion (32) of the bottom surface (3), and the first contact point (61) is shorter than the shortest distance (L2) between a fourth contact point (64), where the first corner portion (31) is connected to another edge portion (33) of the bottom surface (3) adjacent to the edge portion (32), and the second contact point (61).

Through the above configuration, when the cutting insert of the present invention is used for high-feed ramping, the clearance angle on the inner side (the side of the first corner cutting edge) of the cutting insert can be appropriately secured while reinforcing the rigidity of the main cutting edge.

Meanwhile, as shown in FIG. 3, the top surface (1) is provided with a plurality of concave dimples (11) along the cutting edge, and the plurality of dimples (11) gradually increase in length from the first contact point (61) toward the second contact point (62). Through this configuration, it is possible to achieve an effect of dispersing heat when machining high-hardness mold materials, and by gradually increasing the length of the dimples, the heat-dissipating effect can be maximized as the depth of cut increases.

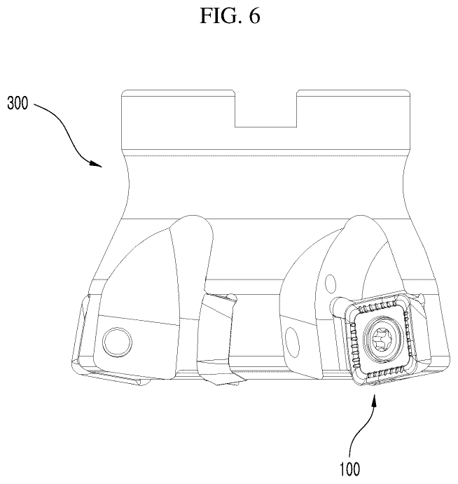

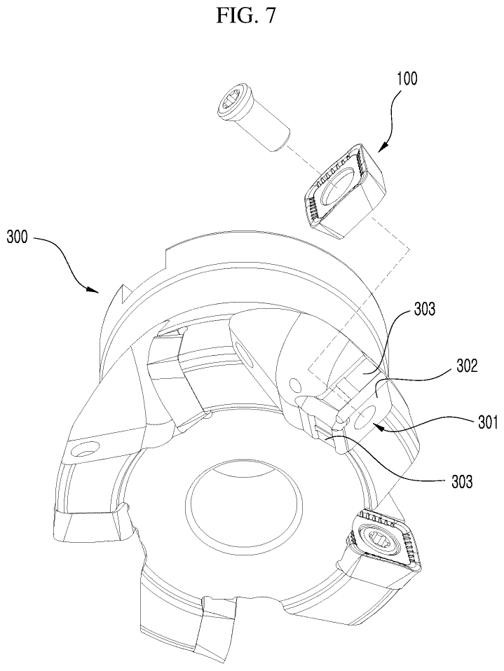

Hereinafter, with reference to FIGS. 6 and 7, a cutting tool (300) equipped with the cutting insert (100) according to an embodiment of the present invention having the above-described configuration will be briefly described.

The cutting tool (300) is provided with a plurality of pocket portions (301) in which the cutting insert (100) is mounted.

The pocket portion (301) includes a bottom seat portion (302) on which the bottom surface (3) of the cutting insert (100) is seated, and two side seat portions (303) on which the side surfaces (2) of the cutting insert (100) are seated. The side seat portions (303) are formed of flat surfaces having grooves.

As described above, in the cutting insert of the present invention, the corner R shape is formed to be symmetrical on the top surface and asymmetrical on the bottom surface, so that, during ramping, a sufficient clearance angle can be secured on the inner side of the cutting insert where clearance is required, and rigidity can be secured in portions requiring strength, such as the portion where the main cutting edge starts.

In addition, by forming the helix shape of the main cutting edge as an asymmetrical upwardly convex shape so that chips are discharged in place, the unused corner can be protected, thereby extending the service life of the cutting insert.

While the preferred embodiments of the present invention have been described in detail above, the scope of the present invention is not limited thereto, and various modifications and improvements made by those skilled in the art using the basic concept of the present invention defined in the following claims are also included within the scope of the present invention.

### INDUSTRIAL APPLICABILITY

The cutting insert according to the present invention can be used in the field of cutting tools.

1. A cutting insert comprising: a top surface; a bottom surface; a side surface; a fastening hole penetrating the top surface and the bottom surface; and a cutting edge at which the top surface and the side surface are connected to each other,
wherein the cutting edge includes a main cutting edge, a first corner cutting edge extending from one side of the main cutting edge, and a second corner cutting edge extending from the other side of the main cutting edge,
wherein, when viewed from the side surface, the main cutting edge has an asymmetrical upwardly convex shape with respect to an imaginary center line passing through the fastening hole,
wherein, when viewed from the top surface, the main cutting edge has a straight shape, and
wherein a first contact point where the main cutting edge and the first corner cutting edge meet is positioned higher from the bottom surface than a second contact point where another main cutting edge adjacent to the main cutting edge and the first corner cutting edge meet.

2. The cutting insert according to claim 1,
wherein, when viewed from the top surface, the cutting insert is rotationally symmetrical at 90°×n (where n is a natural number) with respect to the imaginary center line,
wherein the first corner cutting edge is symmetrical with respect to an imaginary diagonal center line passing through the center of the fastening hole, and
wherein the second corner cutting edge is symmetrical with respect to another imaginary diagonal center line passing through the center of the fastening hole.

3. The cutting insert according to claim 2,
wherein a first corner portion of the bottom surface corresponding to the first corner cutting edge is asymmetrical with respect to the imaginary diagonal center line, and
wherein a second corner portion of the bottom surface corresponding to the second corner cutting edge is asymmetrical with respect to the imaginary diagonal center line.

4. The cutting insert according to claim 1,
wherein a corner clearance surface extending from the first corner cutting edge has a clearance angle that increases from the first contact point toward the second contact point.

5. The cutting insert according to claim 2,
wherein the shortest distance between a third contact point, where the first corner portion is connected to an edge portion of the bottom surface, and the first contact point is shorter than the shortest distance between a fourth contact point, where the first corner portion is connected to another edge portion of the bottom surface adjacent to the edge portion, and the second contact point.

6. The cutting insert according to claim 1,
wherein the top surface is provided with a plurality of concave dimples along the cutting edge, and the plurality of dimples gradually increase in length from the first contact point toward the second contact point.

7. A cutting tool in which the cutting insert according to claim 1 is mounted.
